(19) United States
(12) Patent Application Publication
(10) Pub. No.: US 2025/0090392 A1
(43) Pub. Date: Mar. 20, 2025

(54) MEDICAL VEHICLE COMPRISING A COMPARTMENT WITH A MEDICAL IMAGING SYSTEM AND METHOD FOR OPERATING A MEDICAL VEHICLE

(71) Applicant: KONINKLIJKE PHILIPS N.V., EINDHOVEN (NL)

(72) Inventors: MARK THOMAS JOHNSON, ARENDONK (BE); NAGARAJU BUSSA, BANGALORE (IN)

(21) Appl. No.: 18/729,299

(22) PCT Filed: Jan. 12, 2023
(86) PCT No.: PCT/EP2023/050652

§ 371 Date: Jul. 16, 2024

(30) Foreign Application Priority Data
Jan. 17, 2022 (EP) 22151827.7

(51) Int. Cl. A61G 3/00

(52) U.S. Cl. CPC A61G 3/001; A61G 3/006; A61G 2203/30; A61G 2210/50

(57) ABSTRACT

The invention relates to a medical vehicle (1) comprising a compartment (2) with a medical imaging system (3), wherein the medical imaging system (3) comprises at least one system support sensor (4). The system support sensors (4) augment the vehicle's own sensors and/or replace equivalent sensors in the vehicle. The medical vehicle (1) is configured to obtain sensor readings from the at least one system support sensor (4) during operation of the medical vehicle (1), analyze the sensor readings and provide feedback based on the analyzed sensor readings. The invention further relates to a corresponding method for operating a medical vehicle (1).

### FIELD OF THE INVENTION

The invention relates to a medical vehicle comprising a compartment with a medical imaging system and to a method for operating a medical vehicle.

### BACKGROUND OF THE INVENTION

Vehicle-based medical imaging solutions provide, for example, medical imaging at remote places. During the transportation of the imaging systems, they will be subjected to forces caused by the motion of the vehicle. Said forces may damage the imaging system such that a re-calibration or even an unscheduled maintenance is required. Also, the vehicle may be damaged during the transport.

International patent application WO 03/020550 A2 discloses an intravehicular tertiary health care system for patients that is dynamically stabilised by multiple-stage pneumatic and hydraulic impact-isolators that attenuate the effect of severe shocks and that are monitored by a plurality of 3-axis accelerometers.

### SUMMARY OF THE INVENTION

It is an object of the present invention to provide a medical vehicle that is configured to assess adverse conditions for a medical imaging system of the medical vehicle while keeping the cost increase of the medical vehicle moderate. It is a further object of the present invention to provide a method for operating a medical vehicle that assesses adverse conditions for the medical imaging system.

The object of the present invention is solved by the subject-matter of the independent claims, wherein further embodiments are incorporated in the dependent claims.

In an aspect of the present invention, a medical vehicle comprising a compartment with a medical imaging system is provided. Said medical vehicle may offer mobile diagnostic imaging. The compartment may be just large enough to fit the medical imaging system, but it may also provide extra space next to the medical imaging system. The compartment may comprise physical walls, but could alternatively be a virtual compartment defined by a volume of an existing compartment of the vehicle.

The medical imaging system comprises at least one system support sensor. Said system support sensor may be used to assess adverse conditions for the medical imaging system.

The system support sensors augment the vehicle's own sensors. In other words, the system support sensors are used in addition to the vehicle's own sensors, providing even better sensor readings and assessments. Additionally or alternatively, the system support sensors replace equivalent sensors in the vehicle. For this, the system support sensors may be connected by a wired and/or wireless connection to a computing system of the vehicle, such as a controller area network. Hence, the number of sensors in the medical vehicle is reduced, which reduces the cost of the medical vehicle and reduces the complexity of the vehicle.

The medical vehicle is configured to obtain sensor readings from the at least one system support sensor during operation of the medical vehicle. In this context, operation may refer to travel of the medical vehicle but may also encompass a stationary medical vehicle, e.g., with the engine running. Since said system support sensor is already present in the medical imaging system, there is no need to add an extra sensor, which may result in considerable cost savings.

The medical vehicle is further configured to analyze the sensor readings and to provide feedback based on the analyzed sensor readings. The sensor readings may be, in particular, analyzed to assess adverse conditions for the medical imaging system and the provided feedback may remedy said adverse conditions. And since the system support sensor is already present in the medical imaging system, said assessment of adverse conditions and feedback to remedy the adverse conditions may be obtained at a very low cost.

According to an embodiment, the medical vehicle is a truck, a train, a plane, a helicopter, an autonomous flight object and/or a ship. In all of said vehicles, a medical imaging system may be installed and may be transported. Adverse conditions may stem from, e.g., potholes, corners, hills, turbulences, or waves and may be assessed using the sensor readings from the at least one system support sensor.

According to an embodiment, the medical imaging system is a magnetic resonance imaging (MRI), a computed tomography (CT), a digital X-ray radiogrammetry (DXR), and/or a positron emission tomography (PET) system. Each of these systems is very sensitive to force acting upon it and hence an assessment of adverse conditions is very valuable.

According to an embodiment, the at least one system support sensor is an inertial measurement unit (IMU), an accelerometer, a magnetic field sensor, an optical sensor, a camera, a motion and/or vibration sensor, and/or an environmental sensor. While most of said sensors may be used to assess an impact forces, the environmental sensor may measure a temperature and/or a humidity in the compartment housing the medical imaging system.

According to an embodiment, the analysis of the sensor readings comprises the detection of an impact force on the compartment housing the medical imaging system. In this context, impact force may be any force other than the gravitational force. In particular, impact forces may be forces due to an acceleration of the compartment housing the medical imaging system. Such a detection of the impact force may be readily performed with an IMU, an accelerometer and/or a motion sensor. The detection of an impact force may also be performed with a camera, wherein a shaking of the image contents may be considered as an impact on the compartment.

According to an embodiment, if the impact force exceeds a predetermined first impact force threshold, the feedback is provided to a vehicle management system of the medical vehicle and comprises an adaptation of the vehicle settings. The vehicle management system may be, e.g., an on-board vehicle computer and the adaptation may be a control of the vehicle's speed and/or an adaptation of an active suspension of the vehicle. Controlling the vehicle's speed may be performed, e.g., via an adaptive cruise control or via a speed limit presented to the operator, e.g., driver. Once the vehicle has slowed down, the impact forces acting on the medical imaging system and on the vehicle will also be reduced Also, by performing an adaptation of the active suspension of the vehicle, the active suspension parameters are reconfigured such that the forces action on the imaging system are reduced. In conclusion, the driving of the vehicle is improved and the risk for damage to the medical imaging system or to the vehicle is reduced such that even less experienced drivers may safely operate the vehicle.

According to an embodiment, if the impact force exceeds a predetermined second impact force threshold, the analysis of the sensor readings further comprises a prediction of possible damage done to the medical vehicle and/or the medical imaging system. Said second impact force threshold may be higher than the first impact force threshold, such that only those impacts are analyzed regarding possible damage that could not be prevented by, e.g., reducing the speed of the medical vehicle or adapting the active suspension system. The feedback that is provided is then an alert for repair of the medical vehicle and/or the medical imaging system. Said alert for repair may be provided to a user interface such that, e.g., an operator of the medical vehicle is notified to have the medical imaging system and/or the medical vehicle checked and, if necessary, re-calibrated and/or repaired.

According to an embodiment, the analysis of the sensor readings comprises the detection of a vibration of the compartment housing the medical imaging system. Said detection of a vibration may be performed, e.g., by the IMU, the accelerometer and/or the vibration sensor. A detection with the camera may also be possible, when the vibrations are visible in the image taken by the camera. If the vibration exceeds a predetermined vibration threshold, the feedback is provided to an engine management system of the medical vehicle and comprises a change of the engine settings, in particular a change of the revolution speed. Hence, the likely cause of the vibrations, namely resonant vibrations driven by vibrations of the engine, which may occur both during travel of the medical vehicle and when the medical is stationary, has been removed by changing the revolution speed and therefore moving the engine vibrations away from the resonance peak. Less vibrations imply reduced forces on the imaging system, preventing it from being damaged or from the need for a re-calibration.

According to an embodiment, the analysis of the sensor readings comprises the detection of an irregular movement of the compartment housing the medical imaging system and/or of a movement of parts within the compartment housing the medical imaging system. Such irregular movement of the compartment and/or movement of parts within the compartment may indicate that mounting of the compartment has become loose or that parts within the compartment are loose. In this case, further motion of the vehicle may lead to severe damage due to the loose part moving around and hence the feedback may comprise an alert stating that the compartment and the medical imaging system are to be inspected at the earliest convenience.

According to an embodiment, the analysis of the sensor readings comprises the detection of environmental parameters, in particular temperature and/or humidity, in the compartment housing the medical imaging system. Usually, medical imaging systems are to be kept at a predetermined temperature and humidity range. Hence, if the environmental parameters lie outside of the predetermined range, the feedback is provided to the vehicle management system and comprises an adaptation of environmental conditioning settings, in particular air conditioning settings, such that, in particular, the compartment and the medical imaging system are cooled or heated such that their temperature is back to the predetermined range.

In another aspect of the invention, a method for operating a medical vehicle according to the above description is provided. The method comprises obtaining sensor readings from the at least one system support sensor during operation of the medical vehicle, analyzing the sensor readings, and providing feedback based on the analyzed sensor readings. In particular, the sensor readings may be analyzed to assess adverse conditions for the medical imaging system and the provided feedback may remedy said adverse conditions. And since the system support sensor is already present in the medical imaging system, said assessment of adverse conditions and feedback to remedy the adverse conditions may be obtained at a very low cost. Also, since the system support sensors augment the vehicle's own sensors and/or replace equivalent sensors in the vehicle, the number of sensors in the medical vehicle is reduced, which reduces the cost of the medical vehicle and reduces the complexity of the vehicle. Further advantages are provided in the above description.

According to an embodiment, analyzing the sensor readings comprises detecting an impact force on the compartment housing the medical imaging system. If said impact force exceeds a predetermined first impact force threshold, the feedback is provided to a vehicle management system of the medical vehicle and comprises an adaptation of the vehicle settings, in particular a control of the vehicle's speed and/or an adaptation of an active suspension of the vehicle. If, however, the impact force exceeds a predetermined second impact force threshold, analyzing the sensor readings further comprises predicting possible damage done to the medical vehicle and/or the medical imaging system. In this case, the feedback is an alert for repair of the medical vehicle and/or the medical imaging system and is provided to a user interface. Further details are explained in the above description.

According to an embodiment, analyzing the sensor readings comprises detecting a vibration of the compartment housing the medical imaging system. If the vibration exceeds a predetermined vibration threshold, the feedback is provided to an engine management system of the medical vehicle and comprises a change of the engine settings, in particular a change of the revolution speed. By moving the vibrations caused by the engine away from the resonant peak, the vibrations will be reduced and forces acting on the medical imaging system will be reduced. Further details are explained in the above description.

According to an embodiment, analyzing the sensor readings comprises detecting environmental parameters, in particular temperature and/or humidity, in the compartment housing the medical imaging system. If the environmental parameters lie outside of a predetermined range, the feedback is provided to the vehicle management system and comprises an adaptation of the air conditioning settings, such that the environmental parameters of the medical imaging system are moved back to the predetermined range. Further details are explained in the above description.

It shall be understood that a preferred embodiment of the invention can also be any combination of the dependent claims with the respective independent claim. These and other aspects of the invention will be apparent from and elucidated with reference to the embodiments described hereinafter.

### BRIEF DESCRIPTION OF THE DRAWINGS

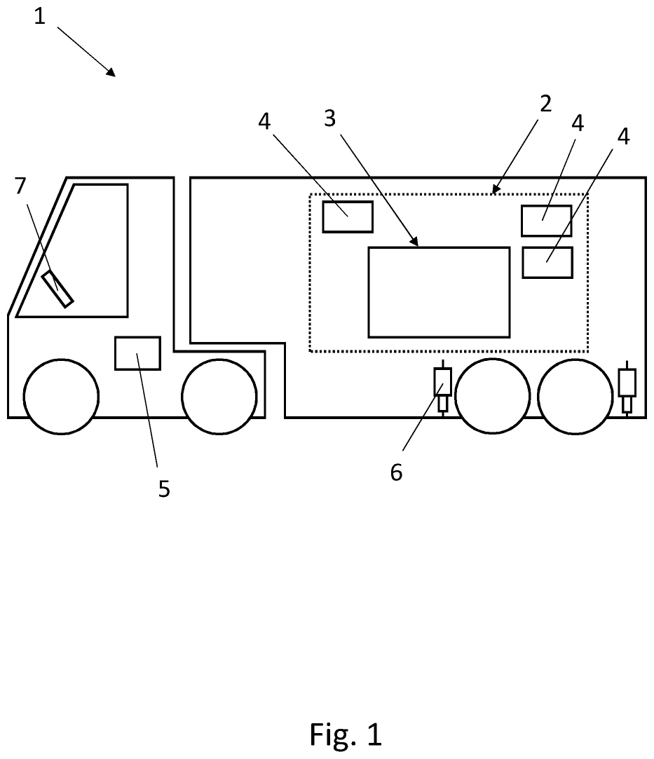

In the following, preferred embodiments of the invention will be described, by way of example only, and with reference to the drawing in which: FIG. 1 shows a schematical side view of a medical vehicle.

### DETAILED DESCRIPTION OF EMBODIMENTS

FIG. 1 shows a schematical side view of a medical vehicle 1. The medical vehicle 1 is depicted as truck, but may as well be a train, a plane, a helicopter, an autonomous flight object or a ship.

The medical vehicle 1 comprises a compartment 2 with a medical imaging system 3. Said medical imaging system 3 may be a magnetic resonance imaging (MRI), a computed tomography (CT), a digital X-ray radiogrammetry (DXR), and/or a positron emission tomography (PET) system.

The medical imaging system 3 comprises three system support sensors 4, however any other number of system support sensors 4 greater than or equal to one is fine. The system support sensors 4 may be inertial measurement units (IMU), accelerometers, magnetic field sensors, cameras, motion and/or vibration sensors, and/or environmental sensors. Said system support sensors 4 augment the vehicle's own sensors and/or replace equivalent sensors in the vehicle 1. Hence, the number of sensors in the medical vehicle 1 is reduced, which reduces the cost of the medical vehicle 1 and reduces the complexity of the vehicle 1.

Sensor readings are obtained from the system support sensors 4 and the sensor readings are analyzed, e.g., by a computing unit that is not shown here. Then, based on the analyzed sensor readings, feedback is provided. Since the system support sensors 4 are used to obtain sensor readings, no extra sensors have to be installed, keeping both the extra cost and the complexity of the medical vehicle 1 low.

As an example, analyzing the sensor readings may comprise detecting an impact force on the compartment 2. If said impact force exceeds a predetermined first impact force threshold, the feedback is provided to a vehicle management system 5 of the medical vehicle 1 and comprises an adaptation of the vehicle settings, in particular a control of the vehicle's speed and/or an adaptation of an active suspension 6 of the vehicle. If, however, the impact force exceeds a predetermined second impact force threshold, analyzing the sensor readings further comprises predicting possible damage done to the medical vehicle 1 and/or the medical imaging system 3. In this case, the feedback is an alert for repair of the medical vehicle 1 and/or the medical imaging system 3 and is provided to a user interface 7.

As another example, analyzing the sensor readings comprises detecting a vibration of the compartment 2. If the vibration exceeds a predetermined vibration threshold, the feedback is provided to an engine management system (not shown here) of the medical vehicle 1 and comprises a change of the engine settings, in particular a change of the revolution speed. By moving the vibrations caused by the engine away from the resonant peak, the vibrations will be reduced and forces acting on the medical imaging system 3 will be reduced.

As yet another example, analyzing the sensor readings comprises detecting environmental parameters, in particular temperature and/or humidity, in the compartment 2. If the environmental parameters lie outside of a predetermined range, the feedback is provided to the vehicle management system 5 and comprises an adaptation of the air conditioning settings, such that the environmental parameters of the medical imaging system 3 are moved back to the predetermined range.

While the invention has been illustrated and described in detail in the drawing and foregoing description, such illustration and description are to be considered illustrative or exemplary and not restrictive; the invention is not limited to the disclosed embodiments. In particular, several embodiments may be combined to provide optimal limitation of gyroscopic forces.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

### LIST OF REFERENCE SIGNS

1 Medical vehicle
2 Compartment
3 Medical imaging system
4 System support sensor
5 Vehicle management system
6 Active suspension
7 User interface

1. A medical vehicle comprising a compartment with a medical imaging system, wherein the medical imaging system comprises at least one system support sensor, wherein the system support sensors augment the vehicle's own sensors and/or replace equivalent sensors in the vehicle, and the medical vehicle is configured to
obtain sensor readings from the at least one system support sensor during operation of the medical vehicle;
analyze the sensor readings; and
provide feedback based on the analyzed sensor readings.

2. The medical vehicle according to claim 1, wherein the medical vehicle is at least one of a truck, a train, a plane, a helicopter, an autonomous flight object, and a ship.

3. The medical vehicle according to claim 1, wherein the medical imaging system is at least one of a magnetic resonance imaging, a computed tomography, a digital X-ray and a positron emission tomography.

4. The medical vehicle according to claim 1, wherein the at least one system support sensor is at least one out of a group, the group consisting of an inertial measurement unit, an accelerometer, a magnetic field sensor, an optical sensor, a camera, a motion, a vibration sensor, and an environmental sensor.

5. The medical vehicle according to claim 1, wherein the analysis of the sensor readings comprises the detection of an impact force on the compartment housing the medical imaging system.

6. The medical vehicle according to claim 5, wherein, if the impact force exceeds a predetermined first impact force threshold, the feedback is provided to a vehicle management system of the medical vehicle and comprises an adaptation of the vehicle settings comprising a control of the vehicle's speed and/or an adaptation of an active suspension of the vehicle.

7. The medical vehicle according to claim 5, wherein, if the impact force exceeds a predetermined second impact force threshold, the analysis of the sensor readings further comprises a prediction of possible damage done to the medical vehicle and/or the medical imaging system and the feedback is an alert for repair of the medical vehicle and/or the medical imaging system provided to a user interface.

8. The medical vehicle according to claim 1, wherein the analysis of the sensor readings comprises the detection of a vibration of the compartment housing the medical imaging system, and if the vibration exceeds a predetermined vibration threshold, the feedback is provided to an engine management system of the medical vehicle and comprises a change of the engine settings comprising a change of the revolution speed.

9. The medical vehicle according to claim 1, wherein the analysis of the sensor readings comprises the detection of an irregular movement of the compartment housing the medical imaging system and/or of a movement of parts within the compartment housing the medical imaging system.

10. The medical vehicle according to claim 1, wherein the analysis of the sensor readings comprises the detection of environmental parameters comprising temperature and/or humidity, in the compartment housing the medical imaging system, and if the environmental parameters lie outside of a predetermined range, the feedback is provided to the vehicle management system and comprises an adaptation of environmental conditioning settings.

11. A method for operating a medical vehicle, comprising:
providing a compartment with a medical imaging system in the medical vehicle, wherein the medical imaging system comprises at least one system support sensor, wherein the system support sensors augment the vehicle's own sensors and/or replace equivalent sensors in the vehicle;
obtaining sensor readings from the at least one system support sensor during operation of the medical vehicle;
analyzing the sensor readings; and
providing feedback based on the analyzed sensor readings.

12. The method according to claim 11, wherein analyzing the sensor readings comprises detecting an impact force on the compartment housing the medical imaging system and
if the impact force exceeds a predetermined first impact force threshold, the feedback is provided to a vehicle management system of the medical vehicle and comprises an adaptation of the vehicle settings comprising a control of the vehicle's speed and/or an adaptation of an active suspension (6) of the vehicle; and/or
if the impact force exceeds a predetermined second impact force threshold, analyzing the sensor readings further comprises predicting possible damage done to the medical vehicle and/or the medical imaging system and the feedback is an alert for repair of the medical vehicle and/or the medical imaging system provided to a user interface.

13. The method according to claim 11, wherein analyzing the sensor readings comprises detecting a vibration of the compartment housing the medical imaging system, and if the vibration exceeds a predetermined vibration threshold, the feedback is provided to an engine management system of the medical vehicle and comprises a change of the engine settings comprising a change of the revolution speed.

14. The method according to claim 11, wherein analyzing the sensor readings comprises detecting environmental parameters comprising temperature and/or humidity in the compartment housing the medical imaging system, and if the environmental parameters lie outside of a predetermined range, the feedback is provided to the vehicle management system and comprises an adaptation of the air conditioning settings.
